(19) United States
(12) Patent Application Publication
(10) Pub. No.: US 2021/0267144 A1
(43) Pub. Date: Sep. 2, 2021

(54) PLANT MATERIAL COATING AND PREPARATION PROCEDURE

(71) Applicants: ARCOR S.A.I.C, Buenos Aires (AR); ARCOR AG, ZUG (CH); ESTACION EXPERIMENTAL AGROINDUSTRIAL OBISPO COLOMBRES, Departamento Tafi Viejo Tucuman (AR)

(72) Inventors: MARCELO LUIS MARANZANA, Buenos Aires (AR); GABRIEL RAYA TONETTI, Buenos Aires (AR); RICARDO GUSTAVO ERASO, Buenos Aires (AR); ERIQUE ANTONIO VALENTI, Buenos Aires (AR); MARIA SILVANA LISI, Buenos Aires (AR); CECILIA ESTEFANIA MONTES DE OCA, Buenos Aires (AR); PATRICIA ANDREA DIGONZELLI, Buenos Aires (AR); EDUARDO RAUL ROMERO, Buenos Aires (AR); MARIA LAURA TORTORA, Buenos Aires (AR); MARIA FERNANDA LEGGIO, Buenos Aires (AR); JUAN GIARDINA, Buenos Aires (AR)

(21) Appl. No.: 17/254,446

(22) PCT Filed: Nov. 26, 2018
(86) PCT No.: PCT/IB2018/059308

§ 371 Date: Dec. 21, 2020

(30) Foreign Application Priority Data
Jun. 26, 2018 (AR) 20180101778

(51) Int. Cl. A01G 24/25; A01G 22/55; A01C 1/06

(52) U.S. Cl. CPC A01G 24/25; A01C 1/06; A01G 22/55

(57) ABSTRACT

Vegetable material coating subject to dehydration and oxidation, sugar cane buds or setts preferably, which involve a substrate, an agglutinant agent, a plasticizing agent, and a biodegradable film or coverage. Such substrate can be from commercial crops, earth, cellulose, corn shell or other cereals, perlome, bagasse, fertile earth, compost, sand, coconut fibre or other vegetable origin fibres, or their combinations. The agglutinant agent can be proteins, fat, vegetable gums, modified starch and/or starch gels, dextrins, maltodextrins, carboxymetylcellulose, cellulose, kitosane mixed with polyalcohols, pectin, agar, alginate, sorbitol or other polyalcohols, glycerides, such as fats and vegetable and animal oils, water-proofing agents, polymeric plasticizing agents, phosphates, acetyl monoglycerides, glycerol, gat acids, sorbitol or other polyalcohols. Coating can be polysaccharides of a protein, lepidic composition or a combination of both, microperforated film, parafilm, and PLA (polylactic acid), biodegradable film poly (lactic acid), poly (hydroxybutyrate), poly (hydroxybutyrate-co-valerate), or their mixtures. Fats, pectins, cellulose, waxes, starch films or other polysaccharides, alginate, calcium carbonate, vinyl coatings, plastic paints. Mixtures can be obtained from solution mixing, preformed matrix resulting from moulting or merging. The biodegradable film or coating can comprise different types of perforations, for instance, circular, lengthwise, perforations, cuts, inserts, notches, etc. Moreover, it can be of different colours according to the variety, storage time, planting time, etc. Such coating can be vacuum sealed, by means of double thermal sealing, etc.

This invention is related to a plant material coating subject to dehydration and oxidation, more precisely of buds or setts of sugar cane and how it is prepared. This coating involves a substrate or mixtures, an agglutinant agent or mixtures, a plasticizing agent or mixes, and a bio-degradable film as coating and its related procedure.

### BACKGROUND

A seed or part of a plant coating must provide protection to the plant against mechanical damage; it must be sufficiently soft so that such coating can be broken down at the time of germination. Any matrices or polymeric products used to coat plant material must also be able to withhold nutrients, allow gas exchange and avoid excessive evaporation to the environment.

Currently, several polymers are used to coat seeds, such as alginate. Such coating must also be harm-free for the plant. Alginate is basically used as a collection matrix for cells and enzymes, as well as for additives and nutrition supplements. The encapsulation process or seed coating largely relies on chemical properties of polymers used and their resulting structures.

Synthetic seed plant propagation has been extended to different plant species, including cereals, fruit and vegetable, medicinal plants, forestry trees, citrus, and ornamental plants.

### BRIEF DESCRIPTION OF INVENTION

A plant material coating subject to dehydration and oxidation is provided; more precisely a material coming from buds or stakes of sugar cane involving a substrate or mixes, an agglutinant or mixes, a plasticizing agent or mixes, and a bio-degradable film as coating.

A preferred substrate composition could be substrates of commercial crops, soil, cellulose, corn or other cereals shell, corn or other cereals husks, perlome, bagasse, fertile earth, compost, sand, coconut fibre, or other plant fibres, or their mixture.

A preferred composition can involve an agglutinant such as proteins, fats, vegetable gums, starch-based or modified starch gels, dextrins, maltodextrins, carboxymetylcellulose, cellulose, kitosane mixed with polyalcohols, pectin, agar, alginate, sorbitol, or other poly alcohols, glycerides such as gats and plant and animal oils, animal, vegetal or mineral waxes, resins.

In another preferred composition the plasticizing agent can be resins, waxes, gums, fats or animal or vegetable oils, waterproofing materials, polymeric plasticizing agents, phosphates, acetyl monoglycerides, glycerol, fat acids, sorbitol or other polyalcohols

Agglutinates, plasticizing agents, or a combination of the two can be added fungicide agents, bactericide agents, insecticide agents, nematicide agents, molluscicides, biological products, acaricides, pesticides, and biocides. Fungicides involve, for instance, nitriloxym, imidazole, triazol, sulphonamide, dithiocarbamate, chloride -aromatized, and dichloroaniline fungicides.

The biodegradable film can be a protein, lipid or mixed nature polysaccharide, a microperforated film, parafilm and PLA (polylactic acid), poly (lactic acid), poly (hydroxybutyrate), poly (hydroxybutyrate-co-valerate), or their mixture, fats, pectins, cellulose, waxes, starch films or other polysaccharides, alginate, calcium carbonate, vinyl coatings, plastic paintings. Mixtures can be formed by mixing solutions, a preformed matrix from a moulding or merger mixture. The biodegradable coating comprise different types of perforations, such as circular, lengthwise perforations, cuts, incisions, notches, etc. . . . In a preferred embodiment, circular perforated are preferred between 0.5 mm to 2 mm wide. Also, they can be of a variety of colours, depending on their type, storage period, planting time, etc.

Coating can be vacuum-sealed, double-sealed or thermally sealed, etc.

In a preferred embodiment, soil is used as substrate; the following can act as agglutinate: an acrylic water-proofing agent, cattle fat, high grade sunflower oil, 4% (w/v) modified starch-based gel, 6% (w/v) modified starch-based gel, 8% (w/v) modified starch-based gel, 4% modified starch-based gel+toasted corn shell and/or 4% (w/v) modified starch-based gel+corn husk; the plasticizing agent is glycerol and the biodegradable film is a microperforated film, parafilm, and/or PLA (polylactic acid).

The plant material coating procedure consisting of sugar cane buds or stakes involves at least the following stages:

a) kneading, integrating the substrate or mixtures by hand or mechanically with an agglutinant agent and a plasticizing agent, and adding the plant material, i.e. sugar cane buds or stakes. The resulting truffle can be of several sizes and obtained in different ways: cylindrical, spherical, oval, etc; and

b) covering the above-mentioned (truffle) with a biodegradable film or coating. This procedure may involve, but is not limited to, adding growth enhancers such as grow promoting bacteria and fungi, growing factors, phytohormones, amino acids, fertilizers, biofertilizers, organic fertilizers, mineral salts, supplements, macro and micro-nutrients, ripeners, etc., fungicides with physiologic effect such as strobilurins and pyraclostrobin, in particular, for example, Carbendazim, Acronis (metyltiophanate+pyraclostrobin), F500 (pyraclostrobin), etc. The biodegradable film or coating is perforated.

Afterwards, it can be stored for 0 to 100 days at different suboptimal temperatures (lower than 16° C.) and humidity ranging from 70%-99%.

### DESCRIPTION OF FIGURES

FIG. 1 is a graph which shows bud weight according to several encapsulation treatments after storage at 14-16° C. [symbol] (-- --), Gel [symbol] shell (-- --). Gel+husk (...), Water-proofing agent 50% ( [symbol] ), Water-proofing agent 10 [symbol] ( [symbol] ), [symbol] (...), Gel 4% ( ), Gel 6 [symbol] (...+...), Gel 8% (-----), AGAO ( [symbol] ).

FIG. 2 is a graph which shows dehydration (%) of buds in several encapsulation treatments after storage at 14-16° C.

FIG. 3 shows a graph indicating results corresponding to weight loss of buds [symbol] everal encapsulation treatments with or without fungicides, at 24, 96, 120 and 144 hour storage. [symbol] ness ( ), Fungicide [symbol] +gel 4% (- -) [symbol] , Fungicide 1 ( [symbol] ...), Fugicide 2 (...), [symbol] Fungicide 2+gel 4% ( ), Fungicide 1+oil (-- --), Fungicide 1+dextrines (- . -), [symbol] Fungicide 1+vegetal fat (-.-), Fungicide 1+palmel fat (-.-).

FIG. 4 is a graph which shows dehydration (%) of buds in several encapsulation treatments with or without fungicide, after a 144 hour-storage at 14-16° C.

FIG. 5 shows pictures of how truffled prepared with a commercial substrate (Grow Mix, Terrafertil) and modified starch gels look like.

FIG. 6 is a graph which shows dehydration (%) of buds in several encapsulation treatments with or without fungicide, at 14-16° C.

FIG. 7 shows how truffles look depending on different coating treatments: a) witness truffles, b) microperforated film coated truffles, C) parafilm coated truffles, D) PLA coated truffles, and E) 6% starch gel film encapsulated truffle.

Figur [symbol] shows a graph with the dehydrating perce [symbol] e of buds at different storage times (15, 30, and 45 days). Bars corresp [symbol] to ( ) Uncoated [symbol] ; ( ); ( ) Micropore Film ( ) PLA Film; Encapsulated truffles with 6% gel ( ).

FIG. 9 shows dehydration percentages at 15, 30, and 45 day-storage in a cold chamber at different temperatures ( ) 7° C.; ( ) 12.5° C.; ( ) 13.5° C.; ( ) 15° C.

FIG. 10 shows a picture of coated truffles under different coating treatments used for sprouting and growth trials. A) whole PLA, b) two bilateral cut PLA, c) perforated PLA, d) witness truffles without PLA.

FIG. 11 shows: Graph A) Percentage of stem growth. Graph B) Time of growth. ( ) whole PLA; ( ) perforated PLA; ( ) cut PLA; ( ) without PLA.

FIG. 12 shows pictures of the appearance of plants resulting from: A) double-cut PLA coated Truffles; B) whole PLA coated truffles; C) perforated PLA coated truffles; D) Truffles without PLA coating.

FIG. 13 shows the height (A) and diameter (B) of seedlings obtained from truffles: ( ) whole PLA coated; ( ) cut PLA coated; ( ) perforated PLA coated; ( ) without PLA coated.

FIG. 14 shows a graph of the average fresh weight of the stem and root obtained from different coated truffles, ( ) cut PLA; ( ) whole PLA; ( ) perforated PLA; ( ) without PLA.

FIG. 15 shows a graph of the average dry weight of the stalk and root obtained from different coated truffles ( ) whole PLA; ( ) perforated PLA; ( ) cut PLA; ( ) without PLA.

FIG. 16 shows a graph with the percentage of growth of sprouts and roots assed in perforated PLA coated truffles with different diameters: ( ) 0.7 mm; ( ) 1 mm; ( ) 1.2 mm.

FIG. 17 shows a graph with height values (cm), stalk diameter (cm), average number of leaves and tillers of plants resulting from perforated PLA coated truffles with different perforation diameters: ( ) 0.7 mm; ( ) 1 mm; ( ) 1.2 mm.

FIG. 18 shows a picture of the size of sugar cane plants sowed in the field: combined PLA group (left side) (whole PLA coated truffle kept at a cold chamber and perforated at the sowing time) and perforated PLA (right side).

FIG. 19 shows a graph with stack height values, stalk diameter, number of leaves, root dry weight and stalk dry weight ( ). Samppi; ( ) Macrosorb: ( ) Witness truffle.

FIG. 20 shows pictures of the extraction process of buds by means of a puncher.

FIG. 21 shows pictures of the distribution of buds in plastic trays.

FIG. 22 shows pictures of distribution of trays in the sprouting chamber.

### DETAILED DESCRIPTION OF THE INVENTION

For the purposes of this invention, the terms “film” and “pelicula” have the same meaning and are interchangeable. NT: (in the source language both terms are interchangeable, while in English, only ‘film’ considered as ‘coating’ applies.

### Evaluation of Bud Encapsulation

In an early stage, plant material encapsulation tests were carried out. In order to assess degenerative process suffered by isolated buds of the varieties TUC 95-10 and LCP 85-384 during storage under sub-optimal temperatures.

The dehydration time speed of buds with and without encapsulation during storage at sub-optimal temperatures was assessed as well as the effect of the dehydration and oxidation processes on bud viability.

Plasticizing materials used in encapsulation were as follows:

Acrylic water-proofing agent 100%

Acrylic water-proofing agent (diluted in water at 50% v/v)

Cattle fat

AGAO=high oleic sunflower oil

4% (w/v) modified starch-based gel

6% (w/v) modified starch-based gel

8% (w/v) modified starch-based gel

4% (w/v) modified starch-based gel+toasted corn shell (shell 1)

4% modified starch-based gel+toasted corn husk (shell 2)

Witness: encapsulation-free buds

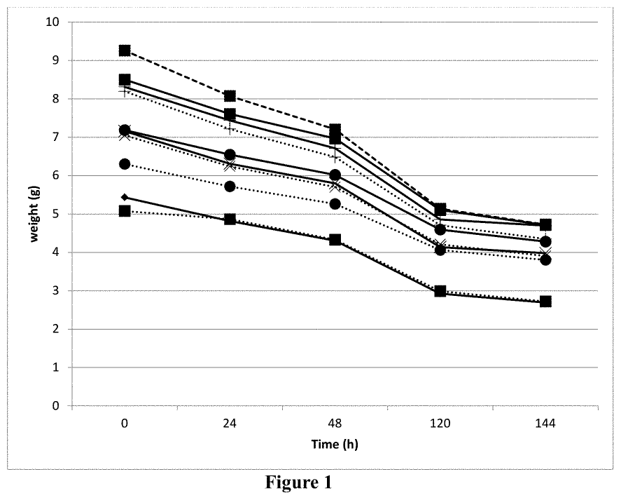

FIG. 1 shows the results corresponding to the bud weight according to different treatments at 24, 48, 120 and 144 hour-storage at 14-16° C.

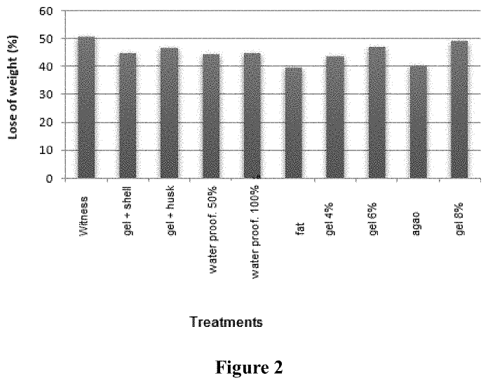

FIG. 2 shows the results stated as dehydration (%) of buds under different treatments at 144 hour-storage.

As per the results obtained, it can be observed that basically all buds from the whole treatments under analysis showed a dehydration (%) slightly lower than untreated witness buds.

### Fungicide Introduction

Considering that during storage fungus growth was present in buds, those treatments with the lowest dehydration % (4% starch gel, cattle fat) and other possible encapsulation materials, were combined with different wide range fungicides: fungicide 1 (Acronis, BASF) used in 1.6% concentration (v/v prepared in water) and fungicide 2 (Carbendazim) used in a 0.2% v/v concentration.

Witness (uncoated buds)

Fungicide 1;

Fungicide 1+4% gel;

Fungicide 2;

Fungicide 2+4% gel;

Fungicide 1+palmel oil;

Fungicide 1+destrins (30% w/v) in water;

Fungicide 1+vegetable fat

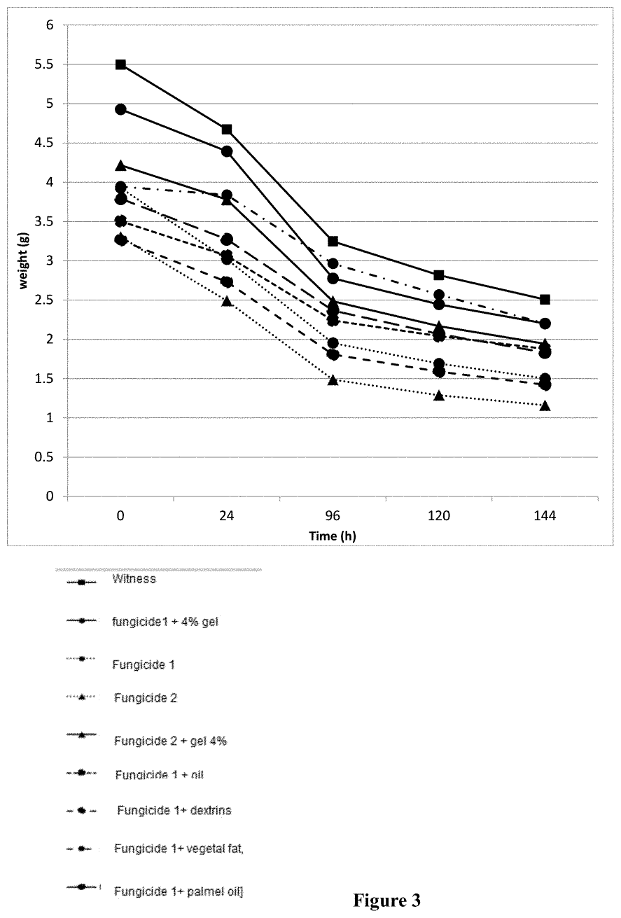

FIG. 3 shows results corresponding to weight loss of buds under different treatments at 24, 96, 120, and 144 hour-storage.

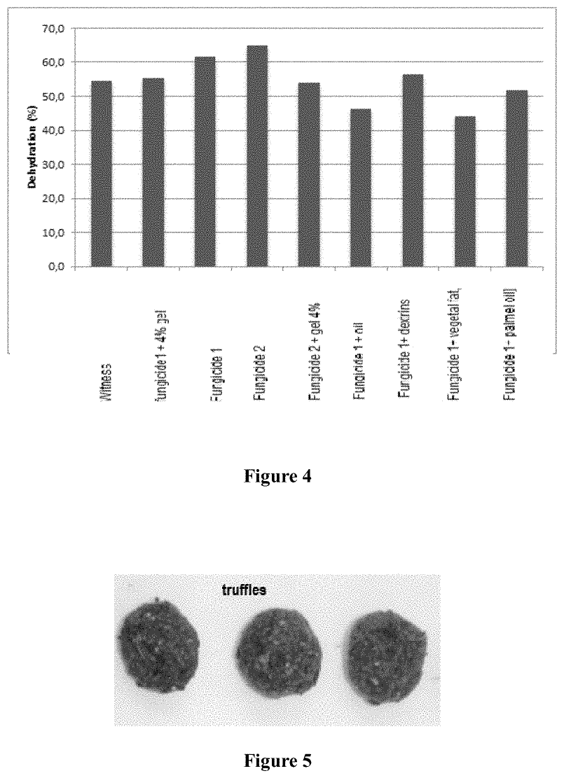

FIG. 4 contains the results corresponding to dehydration % of buds under different treatments at 144 hour-storage in a cold chamber (14-16° C.).

In this case, it is evidenced that fungicide presence does not increase encapsulated bud dehydration percentage during storage; and in general, it prevents infection. Considering such results, it is understood that it is possible to introduce any fungicides to any encapsulation material, all of them being within the scope of this invention.

### Preparation of Coated Buds (“Truffles”)

In order to reduce the observed dehydration rates in previous tests even more, and provide buds with a protecting humid environment, thus avoiding a subsequent steep moisture loss, a new protective formulation containing a substrate that can be either earth or a commercial crop, an equivalent substrate or a mixture was tested. For this end, “truffles” were formed by coating isolated buds with a mixture of a commercial substrate (Grow Mix, Terrafertil) and modified starch-based gels. Once extracted from the setts, and in the same way as the described tests, buds were submerged into a citric acid solution (200 mg/l) until reaching the laboratory. This acid was used as an antioxidant, but it can comprise any other product that behaves as such. Then they were weighted (initial weight Pi), submerged in a fungicide 1 (Acronis 1.6% v/v) solution, and were left drying over a plastic mesh until preparing the truffles.

Mixtures with different proportions of commercial substrates and starch gels were performed in different concentrations. Each mixture was analysed for consistency, ability to form truffles without losing shape or structure, truffle hardness after storage, etc.

Prepared truffles are shown in FIG. 5.

For truffle trials the mixture containing commercial Grow Mix (Terrafertil), 6% (w/v) modified starch-based gel and glycerol in 1:1:0.06 p/p proportions. However, soil, rich soil, and different commercial mixtures can be used to obtain similar results. For instance, commercial Grow Mix (Terrafertil), coconut fibre, Perlome, sand, bagasse, fine commercial substrate, compost, turf, etc., and different starch gels or agglutinants and plasticizing agents can also be used as described above.

Truffles can be stored in a cold chamber at 14-16° C. for 144 days. However, they can also be stored at lower temperatures. After storage, truffles were dismantled and buds were weighted (final weight, Pf) to calculate dehydration percentages, according to this formula:

%Dh=((Pi−Pf)/Pi)*100),

where: % Dh: dehydration percentage;

Pi: initial weight (zero time).

Pf: final weight (post-storage).

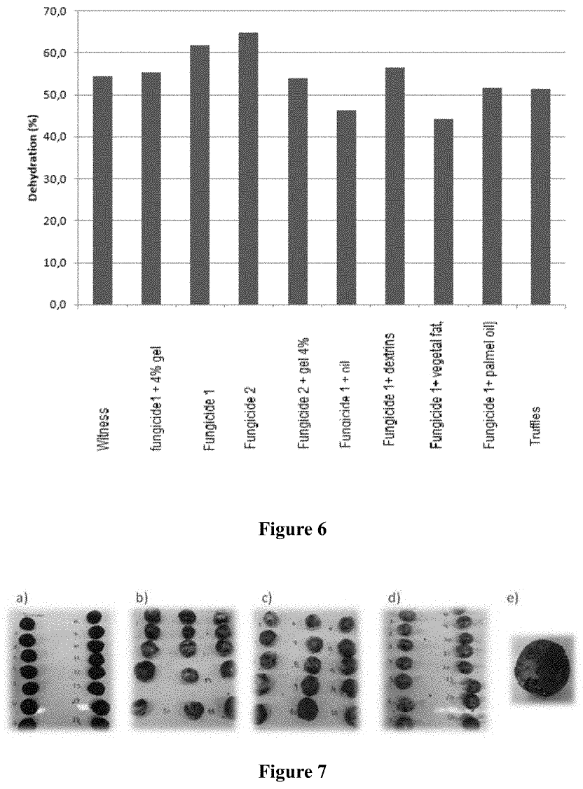

FIG. 6 shows the dehydration results obtained for encapsulated buds after a 144-hour storage, in contrast with buds coated with the materials described in the previous trial, which comprises:

Witness (coating-free buds);

Fungicide 1,

Fungicide 1+4% gel;

Fungicide 2,

Fungicide 2+4% gel,

Fungicide 1+palmel oil,

Fungicide 1+destrins (30% w/v) in water,

Fungicide 1+vegetable fat,

Truffles

As it can be observed, truffles recorded a consistent low dehydration percentage similar to the rest of the analysed treatments.

In order to reduce dehydration rates in truffle buds, different alternatives were evaluated to coat truffles with different films or biodegradable coatings.

From the extraction to the preparation of truffles, bud processing was the same as described in the previous pages. In this case, in order to avoid fungus growth on the truffles, they were prepared by mixing the commercial Grow Mix (Terrafertil) substrate with a 6% (w/v) modified starch gel, glycerol, and the fungicide Acronis (1.6% v/v) was added. Once the truffles were prepared, they were coated with different films or biodegradable coatings and stored in a cold chamber at 14-16° C. These truffles were called “coated Truffles.”

Different varieties of sugar cane obtained from basic seedbeds of Estacion Experimental Obispo Colombres, located in Las Talitas, Tucuman. Analysed treatments were:

witness coating-free truffles (FIG. 7a),

microperforated film coated truffles (FIG. 7b),

parafilm coated truffles (FIG. 7c);

PLA coated truffles (polylactic acid) (FIG. 7d),

truffles with a 6% starch gel layer kneaded with a substrate (FIG. 7e).

The % dehydration of buds was calculated recording the weight of the experimental unit of each treatment before preparing the truffles and at different times (15, 30, and 45 days) after storage in a cold chamber at 14-16° C.

It should be remarked that at the tested storage temperature (14-16° C.), buds begin to sprout. Growing sprouts perforated the parafilm and PLA used to coat the truffles. Micropore film-coated truffles also showed signs of sprouting. Although all coatings showed values lower than 10% of dehydration, the polylactic acid (PLA) was chosen for the following trials for cost-effective reasons, but any biodegradable film or coating is within the scope of this invention.

### Optimization of Storage Conditions

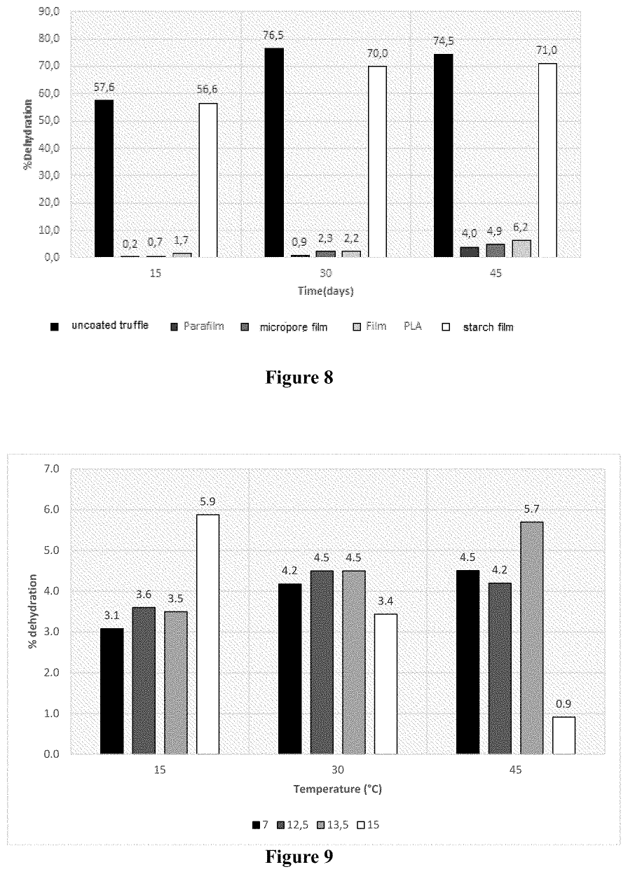

In order to optimize storage conditions, buds were processed and coated truffles were prepared mixing the commercial substrate Grow Mix (Terrafertil) and the 6% (w/v) modified starch gel, glycerol, and Carbendazim fungicide (0.2% v/v) supplement, and finally PLA coating. Coated truffles dehydration was assessed at 15, 30, and 45 day-storage at 7, 12.5, 13.5, and 15° C. (FIG. 9).

As shown by FIG. 9, when storing coated truffles at different temperatures a good bud moisture retention was observed. Based on such results, the preferred storage temperature was within the range of 7 and 15° C., more preferably between 7 and 13.5° C.

### Growth Evaluation

In order to evaluate the behaviour of PLA film coated truffles during sprout growth, truffles under optimal growth conditions were used (30° C. and high percentages of Relative Humidity).

Covered truffles containing sugar cane buds were prepared mixing the commercial substrate Grow Mix (Terrafertil) with the modified starch gel, 6% (w/v), glycerol, and Carbendazim fungicide (0.2% v/v) supplement, and finally PLA coating. PLA coating-free truffles were used as witness.

Immediately after preparing such coated truffles, they were planted in 5-L pots containing a mixture of soil, sand, and perlome (3:2:1 p/p).

An experimental design in random blocks was chosen, comprising 5 blocks with 5 repetitions per treatment. Pots were placed in a hothouse and sprinkle irrigated. The sprouting percentage as well as growth percentage (the latter being understood as the number of sprouts which successfully grew through the PLA in relation to the number of sprouted buds) was assessed.

Whole PLA coated truffles showed lower sprouting and growth percentages. Upon digging up truffles which had failed to grow out of pots, it was observed that buds had sprouted inside the truffle but had not achieved to perforate the PLA coating to be able to grow.

### Single-Node Sett Sugar Cane Procedure

Single-node setts taken from the half-basal portion of sound sugar cane setts from registered seedbeds were used. Extraction of such single-node setts was performed by hand, assisted by a cutting machine previously disinfected with NH4C1 0.1% v/v, specially designed to obtain a consistent size of the initial plant material (3-3.5 cm long). Once extracted, they were processed following the above-mentioned procedure for isolated buds. Earth was kneaded with a plasticizing agent and setts were introduced.

A mixture of the commercial substrate Grow Mix (Terrafertil), 6% (w/v) modified starch gel, and glycerol in 1:1:0.6 p/p proportions was used. However, soil, rich soil, and different commercial mixtures can be used to obtain similar results. For instance, commercial Grow Mix (Terrafertil), coconut fibre, Perlome, sand, bagasse, fine commercial substrate, compost, turf, etc., and different starch gels or agglutinants and plasticizers can also be used as described above.

Then the above-mentioned kneaded compound was coated with a polylactic acid based biodegradable film (PLA) which was subject to different changes to promote growth.

Truffles were stored in a cold chamber at 14-16° C. for 144 hours. Nonetheless they can also be stored at lower temperatures. After storage, truffles were disassembled and setts were weighted (final weight, Pf) to calculate dehydration percentages, according to the previously mentioned formula.

In another trial, 4 groups comprising 20 samples each were used. Such groups were divided according to the changes introduced to PLA.

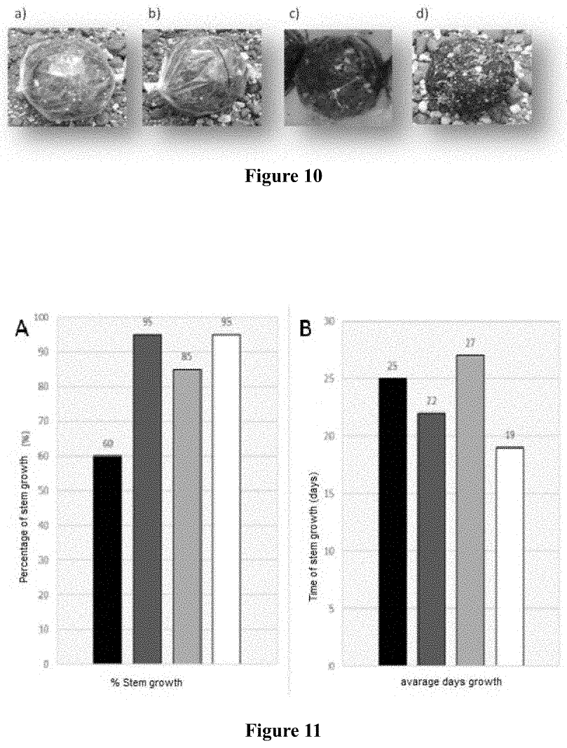

Group S: no PLA, witness (FIG. 10d).

Group E: with whole PLA (FIG. 10a).

Group P: With perforated PLA. Such perforations were performed by hand with a pincer (FIG. 10c).

Group C: PLA with two side cuts (FIG. 10b).

Immediately after preparing such coated truffles, they were planted in 5-L pots containing a mixture of soil, sand, and perlome (3:2:1). An experimental design in random blocks was chosen, comprising 4 blocks with 5 repetitions per treatment. Pots were placed in a hothouse and sprinkler irrigated. The following parameters were evaluated:

Sprouting time

growth percentage

stalk height and diameter

number of leaves

number of tillers

fresh and dry weight of roots and aerial portion

Based on results obtained, whole PLA and cut PLA-coated truffles were observed to have reached values between 60 and 85% of growth. Both witness truffles (PLA-free) as well as perforated PLA truffles showed values equal to 95% of growth in both cases (FIG. 11A).

During the analysis of sprouting speed it was observed that single node setts of witness truffles sprouted 19 days later, then perforated PLA coated truffles sprouted 22 days later, and finally, whole PLA and cut PLA-coated truffles, 25 and 27 days later respectively (FIG. 11B).

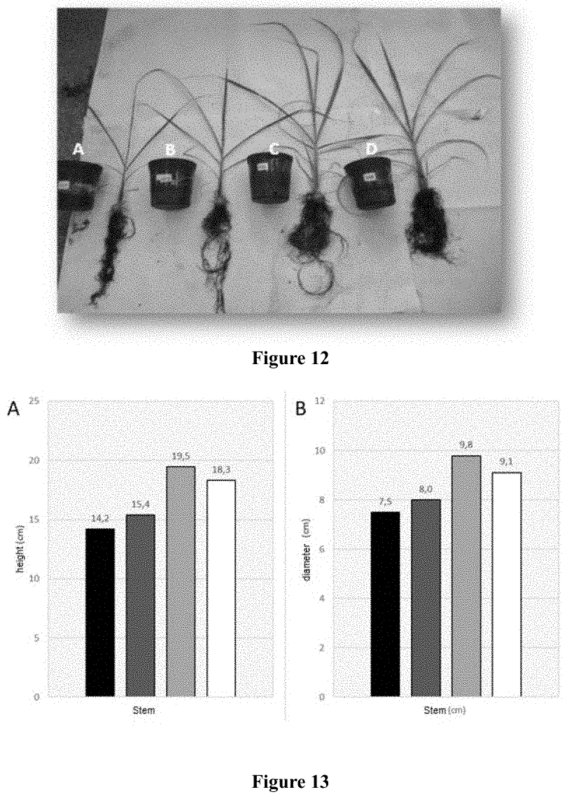

After 68 days from planting the truffles, their height, stalk diameter, number of leaves and developed tillers were measured (FIG. 12). Perforated PLA coated truffles show the best performance in relation to stalk height and diameter (FIGS. 12c and 13), average number of leaves and tillers (see Table 1) in relation to all evaluated treatments. It is important to remark that such values were in some cases, similar to and even higher than the ones recorded by coated-free witness truffles.

TABLE 1

| Coating | Number of leaves | Number of tillers |
|---|---|---|
| Whole PLA | 4 | 1 |
| Cut PLA | 4 | 1 |
| Perforated PLA | 5 | 1 |
| Witness | 5 | 1 |

At the end of the trial, plants were taken from their pots and washed up to remove any earth remains for subsequent analysis of fresh and dry weight of the aerial and radicular system.

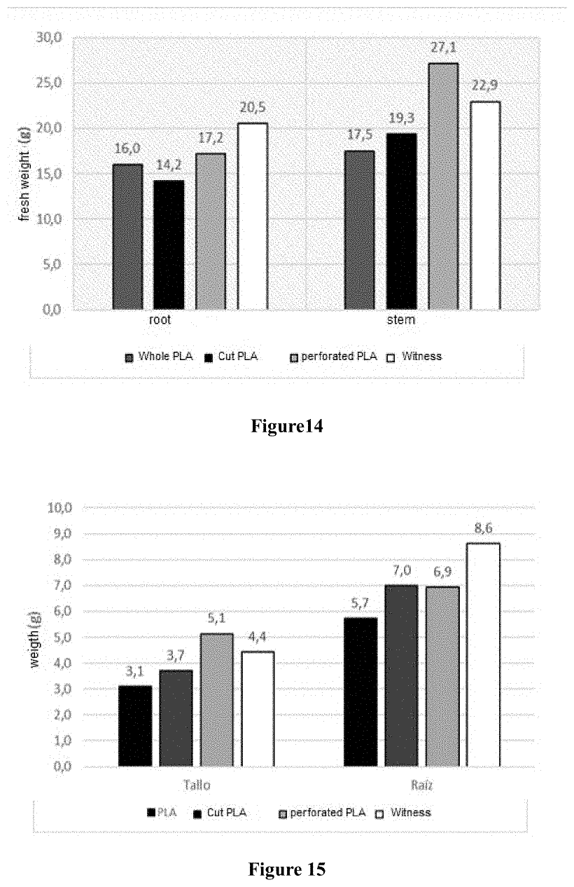

In a similar way to what was observed for the rest of the parameters, plants developed from perforated PLA coated truffles recorded higher growth, fresh and dray weight values as compared to the rest of the evaluated treatments (FIGS. 14 and 15).

According to the results obtained, it can be observed that single node setts contained in truffles coated with several PLA varieties were able to rise and develop normal plants. One of the preferred embodiments was the perforated PLA coated truffle.

### Perforation Diameter of “Coated Truffles” Coating

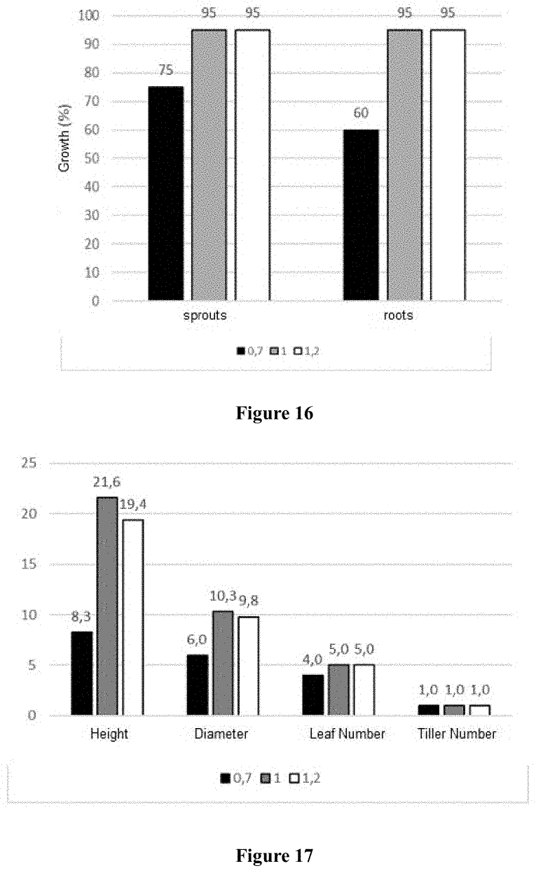

FIG. 16 shows results from tests with different PLA perforation diameters. From data analysis it can be obtained that all of them allowed growth (0.7 mm to 1.2 mm). PLA perforations ranging 1 and 1.2 mm wide are most preferred.

Additionally, plant development parameters were assessed, such as height, diameter, number of leaves and average number of tillers per plant as from 60 days of planting. The development of the plants, both for the 1 mm group and 1.2 mm perforation diameter was the most preferred one. (FIG. 17)

It was decided to analyse if 1 and 1.2 mm perforations could impact on setts dehydration during their storage in cold chambers at 12.5-13.5° C. For this end, truffles form both groups were stored (1 and 1.2 mm perforation diameters) in a cold chamber for 30 days.

It was noticed that both perforations showed a low dehydration percentage. One mm diameter perforations recorded a lower dehydration percentage during storage for 30 days.

### Evaluation of Storage Time

It was observed that 60 days as from storage, whole PLA coated truffles only suffered around 4.4% dehydration, while perforate PLA group setts lost around 26.7% of water.

On the other hand, the viability percentage of stored setts in whole PLA coated truffles was reduced by 10% 60 days after storage, while the viability of the perforated PLA coated truffles stored setts reached an average value of 60%.

Since bud viability was proven to last a longer storage period when truffles are coated with whole PLA, it was decided to study sprouting and the development of buds in plant pots after being stored with a whole PLA film, but perforated at the time of their plantation. This treatment was named “combined PLA.”

The sprouting percentage, height and diameter of stalk, number of leaves, percentage of plants with tillers and fresh and dry weight of the aerial and root portions were evaluated. All the groups kept proper viability percentages (combined PLA, perforated PLA, witness) until 30 days of storage. A slight viability improvement in the combined PLA group was observed after 45 days of storage in a cold chamber.

Regarding the development of sprouted plants, no significant differences are observed between the evaluated groups up to 45 days of storage in a cold chamber (stalk height, diameter, leaf number (Table 2) and root dry weight and aerial portion for both experimental groups.

TABLE 2
Average number of leaves of plants developed from stored truffles.

| | Number of leaves | | | | |
|---|---|---|---|---|---|
| Coating | 0 days | 15 days | 30 days | 45 days | 60 days |
| Combined | 4 | 6 | 6 | 6 | 6 |
| PLA | | | | | |
| Perforated | 4 | 6 | 6 | 5 | 6 |
| PLA | | | | | |
| Witness | 5 | 5 | 5 | 5 | 6 |

In relation to the truffle sowing system, both alternatives are possible to allow their viability, sprouting and development. Whole PLA use for storage largely ensures humidity retention of the plant material and its subsequent perforation assures proper sprouting and development. This allows to increase storage time up to 60 days, guaranteeing a sound development of the sugar cane.

### Field Test

Table 3 shows that setts contained in truffles from both study groups which have been stored in a cold chamber were able to sprout reaching high sprouting percentages (above 70%) per planting furrow.

TABLE 3
Percentage of sprouted buds per furrow in an early field test

| | Furrow 1 | Furrow 2 | Furrow3 |
|---|---|---|---|
| Combined PLA | 76% | 72% | 72% |
| Perforated PLA | 88% | 92% | 88% |

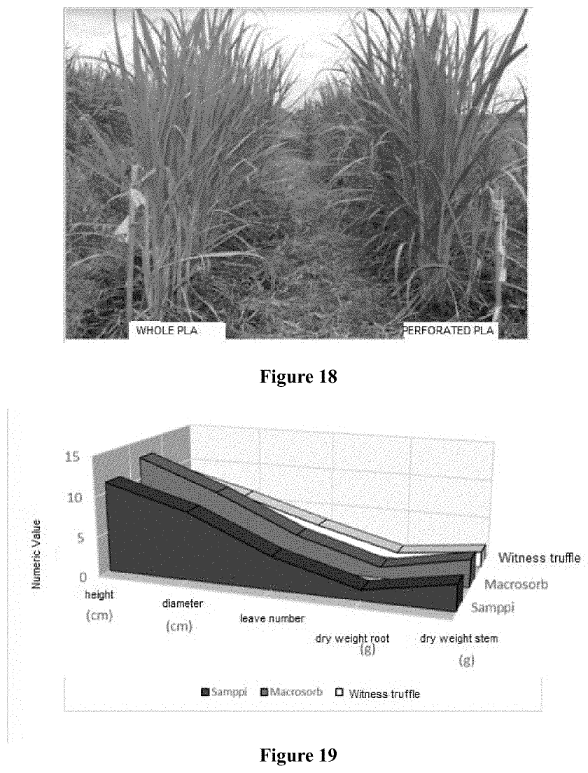

FIG. 18 shows the developed by sugar cane plants grown from single node setts stored in whole PLA coated truffles and perforated PLA coated truffles, both planted in field.

According to the results obtained, it is observed that under uncontrolled field conditions, single node setts contained in PLA coated truffles and stored for example, for 30 days at 12.5-13.5° C. show a good sprouting capacity reaching values higher than 70%. This is noticed when truffles are stored both with a whole and a perforated PLA coating.

### Radicular Growth Promoters

The use of radicular growth promoters successfully reduced the sprouting time of buds to four days in relation to the witness truffle and only required one more day to achieve a 12 cm sett.

After 30 days from planting, different plant development parameters were studied. As shown in FIG. 19, the use of radicular growth promoters such as Macrosorb radicular and Samppi remarkably improved all the plant development parameters as compared to the witness truffle.

TABLE 4
Percentage of sprouted buds and sprouting time of
buds using different radicular growth promoters

| | % Sprouting | Sprouting time (days) |
|---|---|---|
| Samppi | 100 | 11 |
| Macrosorb | 93 | 11 |
| Witness truffle | 80 | 15 |

In order to assess whether such promoters used induce sprouting of the sett or the growth of rootlets from the radicular band during storage, their behaviour was studied after 10, 20, and 30 days of storage in a cold chamber. As witness truffles free of any radicular growth promoter were used. (Table 5)

TABLE 5
Number of sprouted buds with or without rootlets in the radicular
band after storage for 10, 20, and 30 days in a cold chamber.

| | 10 days | 20 days | 30 days |
|---|---|---|---|
| Samppi | 0 | 0 | 0 |
| Macrosorb | 0 | 0 | 0 |
| Witness truffle | 0 | 0 | 0 |

No sprouting induction was observed, nor any rootlets on the radicular band for any of the tested treatments. Using Samppi and Macrosorb radicular growth promoters as components for the preparation of truffles allowed to increase the encapsulated sett sprouting speed, without inducing sprouting during storage at low temperatures.

Storage of perforated PLA coated truffles and whole PLA coated truffles kept a similar dehydration percentage up to 60 days. As from 60 days, whole PLA coated truffles show less dehydration.

Based on the obtained results, it can be determined that whole PLA and perforated PLA coatings allows to keep hydration of setts and their viability for sugar cane varieties during storage periods of up to 60 days.

Sugar cane buds and/or setts were coated with biodegradable material which made it possible to not only store isolated sugar cane buds for long periods of time but also protect and keep their viability after planting and up to the time of sprouting.

This invention is better illustrated in the following examples, which should not be construed as a restriction on the scope of the invention. On the contrary, after reading this description, it must be clearly understood that other embodiments, changes, and equivalent compositions can be recurred to by those experts in the matter without deviating from the spirit and/ or scope of this invention and attached claims.

### EXAMPLES

### Example 1

The dehydration speed of buds with and without encapsulation during storage at sub-optimal temperatures was studied as well as the effect of the dehydration and oxidation processes upon bud viability.

In general, for all test described here isolated buds were used, which were taken from the mean-basal portion of sound sugar cane setts of the variety TUC 95-10 and/or LCP 85-384 from registered seedbeds. Bud extraction was performed by hand with the assistance of a puncher previously disinfected with NH4Cl 0.1% v/v. For consistency purposes, the batch plant material size was determined by a preset weight range. Buds were sorted by hand, discarding damaged ones (FIG. 20).

Considering the risk of oxidation of buds extracted from the field during transportation to the laboratory, isolated buds were immediately submerged into a citric acid solution (200 mg/ litre) during the laboratory transportation time.

Applying different encapsulation materials in different tests was effected by means of spraying and/or submersion according to the characteristics of each material. After encapsulation, buds were left to dry/drain on a plastic mesh.

Once encapsulated with several materials, buds were stored in cold chambers at a temperature of 14-16° C. For this end, an experimental random whole block design. 10 buds belonging to each kind of treatment were placed in plastic trays (experimental unit) (FIG. 21), and were kept in the storage chamber at sub-optimal temperatures between 14-16° C. 5 repetitions were effected per treatment.

Dehydration percentage and sprouting capacity were determined at different time intervals.

The dehydration process of buds was evaluated using the following formula:

%Dh=(Pi−Pf)/Pi)*100),

where: %Dh=dehydration percentage,

Pi: beginning weight (zero time);

Pf: Final weight (post-storage).

An analytic scale was used and the experimental unit weight was registered (buds) of each treatment, before the encapsulation (beginning weight Pi) and different time intervals after the encapsulation and storage (final weight Pf).

Bud oxidation was visually inspected for brown pigments as a result of the oxidation of a variety of plant compounds. The oxidation grade was identified based on the bud colour intensity and coating percentage.

Evaluation of sprouting capacity

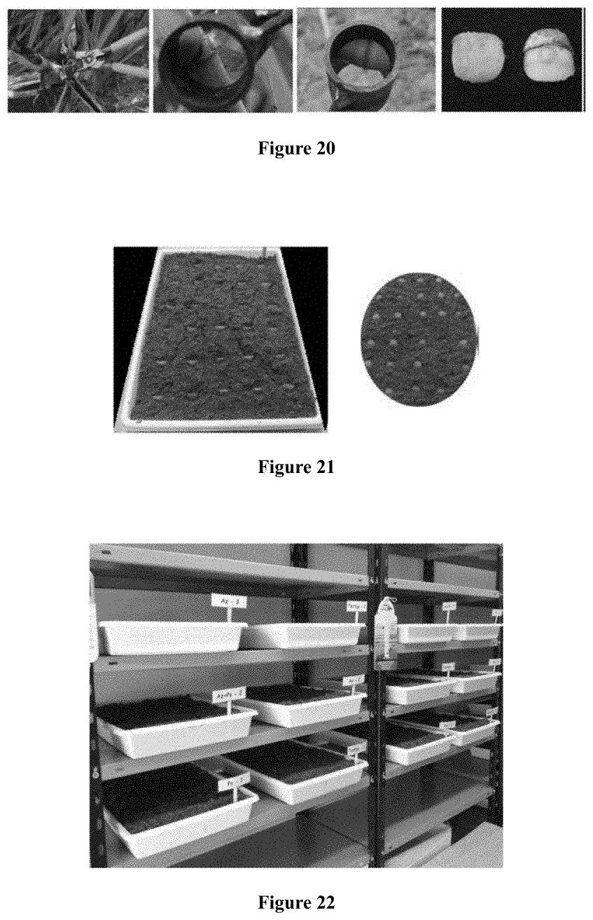

In order to evaluate bud viability after storage, an experimental unit of each treatment (10 buds/setts) was sowed in plastic trays with sand (FIG. 22). Such trays remained in a sprouting chamber at a 30° C. temperature. Encapsulated buds outside storage were used as a control.

Different encapsulation materials were evaluated, such as commercial water-proofing agents, cattle fat, plant oil, corn shell and husk, gels with different concentrations based on modified starch and combination between different materials. In the preparation of gels, different amounts of modified starch were weighted, according to the proportion of the gel to be prepared; it was dissolved into water and the starch suspension was heated at a temperature higher than 72° C. under constant agitation, until reaching starch grain gelatinization. After obtaining the gel, it was left to dry at room temperature and 98% glycerol was added as a plasticizing agent.

Applying different encapsulation materials was effected by means of spraying and/or submersion according to the characteristics of each material. After encapsulation, buds were left to dry/drain on a plastic mesh.

Encapsulation materials were as follows:

Acrylic water-proofing agent 100%

Acrylic water-proofing agent (diluted in water 50% v/v)

Cattle fat

AGAO high oleic sunflower oil

Modified starch-based gel 4% (w/v)

Modified starch-based gel 6% (w/v)

Modified starch-based gel 8% (w/v)

Modified starch-based gel (4%)+toasted corn shell (shell 1)

Modified starch-based gel (4%)+toasted corn husk (shell 2)

After treating buds with different materials, they were stored in a cold chamber at 14-16° C., as described above. Samples were taken at different times and the dehydration percentage was analysed according to the precedent formula.

### Example 2: Encapsulation with Fungicides

After extraction of sugar cane buds, they were submerged in a citric acid solution (200 mg/l) until taking them to the laboratory. Afterwards, they were submerged into one of the fungicide solutions under analysis. They were drained over a plastic mesh for 30 minutes and coated with several encapsulation materials (see materials in example 1).

Once again, they were left to dry over a plastic mesh and stored in a cold chamber at 14-16° for 144 hours. In this case, the analysed treatments were as follows:

Witness (coating-free buds)

Fungicide 1

Fungicide 1+4% starched based gel

Fungicide 2

Fungicide 2+4% starched based gel

Fungicide 1+Palmel oil

Fungicide 1+dextrins (30% p/v) in water

Fungicide 1+vegetable fat.

Note: Fungicide 1: (Acronis, BASF, Active principle pyraclostrobin and methyl tyophanate) used in a 1.6% concentration (v/v prepared in water) and fungicide 2 (Active principle carbendazim) used in a 0.2% concentration v/v).

### Example 3: Truffle Preparation

In order to reduce dehydration rates observed in encapsulation trails, and provide buds with a humid environment that can protect them while avoiding a steep loss of humidity, a protective coating containing a commercial substrate was decided to be evaluated. For this, “truffles” were prepared covering isolated buds with earth as a substrate, for instance, the commercial substrate (Grow Mix, Terrafertil) and modified starch-based gels. Once extracted from stem, and in the same way as the above-mentioned tests, TUC 95-10 variety buds were submerged in a citric acid solution (200 mg/l) until taking to the laboratory. Subsequently, they were weighted (initial Pi weight), they were submerged into a fungicide solution 1 (Acronis 1.6% v/v) and they were drained over a plastic mesh until preparing the truffles.

Mixtures with different proportions (1.1; 1:1.5; 1:2; 1:2,5) of commercial soil substrate and modified starch gels in different concentrations (4, 6, and 8% p/V) were prepared. Each mixture was evaluated for consistency, ability to form truffles without scattering or loosing shape, hardness after storage, etc., for example, truffles from a commercial substrate Grow Mix (Terrafertil) and modifies starch gel 4% (w/v), in proportions 1:1; 1:1,5; 1:2 and 1:2,5; Grow Mix and starch gel 6% in proportions 1:1; 1:1.5; 1:2 and 1:2,5; and Grow Mix and starch gel 8% in proportions 1:1; 1:1.5; 1:2; and 1:2.5.

Other potential substrates to be evaluated could be: commercial crop substrates, earth, cellulose, corn or other cereals shells, corn or other cereals husk, perlome, bagasse, fertile soil, compost, sand, coconut fibre other vegetable origin fibres, or their mixture.

### Example 4: Coating and “Coated Truffles”

In order to reduce dehydration rates of encapsulated buds in truffles, different coating alternatives for truffles with several Films or biodegradable coatings were studied.

Bud processing was the same as described for the previous example, from extraction to final preparation of truffles. In this case, in order to avoid growth of fungus on truffles, they were prepared mixing the commercial substrate Grow Mix (Terrafertil) with the 6% modified starch gel (w/v) and glycerol, supplemented by the Acronis fungicide (1.6% v/v). Once prepared, truffles were coated with different films or biodegradable coatings and stored in a cold chamber at 14-16° C.

Sugar cane varieties from base seedbeds from the Experimental Agri-industrial Plant Obispo Colombres located in Las Talitas, Tucuman, were used.

Treatments under analysis were (FIG. 7):

witness coating-free truffles (a)

microperforated film coated truffle (b)

parafilm coated truffles (c)

PLA coated truffles (polylactic acid) (d)

truffles with a 6% gel film kneaded with substrate (e)

Bud Dehydration (%) was calculated recording the experimental unit weight of each treatment before the preparation of truffles and at different time intervals (15, 30, and 45 days) after storage in a cold chamber at 14-16° C.

### Example 5: Optimization of Storage Conditions

Since bud sprouting during storage period was observed in example 4, on the one hand, it was decided to work with LCP 85-384 variety buds due to their lower sprouting temperatures, and on the other, to establish the optimal storage temperature based on the encapsulated buds at different temperatures.

Therefore, LCP 85-384 sugar cane variety from base seedbeds from the Experimental Plant Obispo Colombres located in Las Talitas, Tucuman, was used.

Bud processing was the same as described for the previous example, from extraction to final preparation of truffles. In this case, in order to avoid growth of fungus on truffles, they were prepared mixing the commercial substrate Grow Mix (Terrafertil) with the 6% modified starch gel (w/v) and glycerol, supplemented by Carbendaxim fungicide (0.2% v/v). In this case, Acronis fungicide was not used since it is a growth and sprouting promoter as well.

Bud dehydration was analysed at 15, 30, and 45 days of storage at 7, 12.5, 13.5, and 15° C.

### Example 6: Growth Evaluation

In order to assess how PLA film coated truffles behave during their growth, storage-free truffles were used under optimal growth conditions (30° C. and high percentages of Relative Humidity).

Truffles containing LCP 85-384 bud variety were prepared following the same above-described protocol and coated with a polylactic acid (PLA) based film. As witness coating-free truffles were used.

Immediately after preparing coated truffles they were planted in 5-litre pots containing earth, sand, and perlome (3:2:1 w/w/w).

An experimental block design was chosen, which was completely at random, distributing truffles in 4 blocks with 5 repetitions per treatment. Such pots were placed in a nursery and sprinkle irrigated. Sprouting and growth percentage was studied (the latter being understood as sprouts which successfully cut through the PLA film in relation to the number of sprouted buds.)

### Example 7: “Truffle” Coating Optimization

For all tests described below, single-node setts extracted from the half-basal portion of sound sugar cane stems of the TUC 95-10 and/or LCP 85-384 from official seedbeds. Hand extraction from single-node setts was applied, assisted by a cutting machine previously disinfected with NH4CI 0.1% v/v, specially designed for consistency of preliminary vegetal material size (3-3.5 cm long). Once extracted, they were processed following the same procedure described above for isolated buds in example no 2.

According to the above-mentioned, once truffles were prepared with single node setts, they were coated with a polylactic acid (PLA) film to which several changes were made in order to promote growth. 4 groups of 20 samples each were used. Such groups were divided according to PLA changes (FIG. 10):

Group S: No PLA, witness (FIG. 10d)

Group E: with whole PLA (FIG. 10a)

Group P: with perforated PLA. Perforations were manually made with a pincer (FIG. 10c).

Group C: PLA with two side cuts (FIG. 10b).

Immediately after preparing coated truffles, they were sowed in 5-Litre pots containing a mixture of earth, sand, and perlome (3:2:1). An experimental design with blocks chosen at random was implemented, using 4 blocks with 5 repetitions per treatment. Pots were placed in hothouses and sprinkler irrigated. The following parameters were studied:

Sprouting time

growth percentage

stem height and diameter

leaf number

tiller number; fresh and dry weight of roots and aerial portions

### Example 8: Optimization of Coating Perforation Diameter of “Truffles”

Truffles were prepared following the same procedure as described above, and coated with perforated PLA film of several sizes: 0.7, 1, and 1.2 mm. Such perforations were uniform, made with a 12×12 cm mould with a punching element, 1 cm distance between one and other so as to achieve a square centimetre perforation.

Unstored truffles were planted in 7-Litre pots containing a mixture of earth, sand, and perlome (3:2:1 w/w/w) and placed in a nursery with a mean temperature of 30° C. Sprout percentage breaking through the PLA film and sprout percentage of roots successfully cutting through the PLA film was studied.

### Example 9: Evaluation of Storage Time

In order to determine for how long coated truffles can be stored, without setts losing their hydration and viability, different storage periods of two treatments were analysed: whole PLA truffles and perforated PLA truffles (1 mm perforations)

Truffles were stored in a cold chamber at 12.5-13.5° C. with an average humidity of 78%. Dehydration percentage and viable sett percentage was established (number of setts sprouting in relation to the total number of analysed setts.)

### Example 10: Field Test

A field test was carried out to analyse the development of single-node setts contained in coated truffles. Truffles were prepared following the same protocol as described above and PLA coated. Then they were stored for 30 days in a cold chamber at 12.5-13.5° C. until they were planted.

Two treatments were used:

1.—PLA-perforated truffles (stored with perforated PLA)

2.—Combined PLA truffles (Stored with who PLA, perforated at plantation time)

Truffles were planted in a field plot in the following way:

3 10 m-furrows

2 5 m-furrow treatment

25 truffles per treatment (5× metre)

The percentage of sprouted buds per furrow for each treatment was determined.

### Example 11: Sprouting Analysis

Once truffles were prepared, they were coated with a whole PLA film (Combined PLA Group) and perforated PLA (perforated PLA Group). Truffles were stored in a cold chamber at an average temperature of 13° C. and a mean humidity of 85%. After 15, 30, 45, and 60 days from storage, truffles were planted in 10-litre pots with a mixture of earth, sand, and perlome (3:2:1 w/w/w) and placed in a nursery with a mean temperature of 25° C. Coated and who PLA stored truffles were perforated at the time of plantation (combined PLA Group). Perforations were 1 mm wide, placed 1 cm away from each other. Uncoated single-node setts cut upon plantation were used as witness.

### Example 12: Root Protomers

Aiming at increasing early bud speed sprouting, 2 different root promoters were used, selected by their ability to increase sprouting speed, stem height and diameter. Tested products were Samppi (Ando y Cia) and Macrosorb radicular (Brometan)

Each product was added to the starch gel used during the truffle preparation. Tested concentrations were 0.5 and 1 ml/l gel for root promoters Samppi (fertilizer containing higher, secondary, and chelated micro-elements, and a natural bioenhancer Macrosorb, composed of amino acids from enzymatic hydrolysis), respectively.

Four treatments with 15 repetitions were carried out:

Truffles with Samppi coated with perforated PLA

Truffles with Macrosorb coated with perforated PLA

Witness Truffle (no promoter, with perforated PLA)

3.5 cm sett (truffle size)

12 cm sett (commercial size)

Truffle sprouting was observed after storage for 3 days at a cold chamber. Truffles from different treatments were planted in 7-litre pots containing a commercial mixture substrate Growmix Premium (Terrafertil), sand, and perlome (in a 3:2:1 w/w/w) proportion. Pots were placed in a nursery under controlled irrigation conditions.

### Example 13: Behaviour of Different Varieties of Sugar Cane

Single node setts from LCP 85-384 and TUC 95-10 variety sugar cane from Base seedbeds in Experimental Plant Colombres, Las Talitas, Tucuman were used. Such selected sugar canes were around 7-9 months old. The bud extraction, processing and truffle preparation was carried out following the same procedure as the one described in previous tests. In this case, to prepare truffles, 6% (p/v) modified starch gel was mixed in a 1:1.5 (p/p) proportion with the commercial substrate Grow Mix (Terrafertil) and manually homogenized. Then, whole and perforated PLA was applied (1 mm perforations).

Bud dehydration was determined by the loss of weight in different fields for 75 days, following the same formula used in previous tests.

1. A coating of plant material which comprises a substrate selected from the group consisting of, soil, cellulose, corn shell, cereal shell, corn husk, cereal husk, bagasse, fertile soil, compost, sand, vegetable fibers, coconut fiber and a mixture of thereof, an agglutinate agaent, a piasticizing agent and a biodegradable film, wherein the plant material is susceptible to dehydration and oxidation.

2. The coating according to claim 1, wherein the material is selected from the group consisting of sugarcane stakes and buds.

3. The coating according to claim 1, wherein the agglutinate agent is selected from the group consisting of acrylic waterproofing, cattle fat, high oleic sunflower oil, 4% modified starch-based gel, 6% w/v modified starch-based gel, 8% w/v modified starch-based gel, 4% w/v modified starch-based gel and toasted corn shell, 4% w/v modified starch-based gel and corn husk, starch, dextrins, maltodextrins, carboxymethyl cellulose, cellulose, chitosan mixed with polyalcohols, pectin, agar, alginate, sorbitol, polyalcohols, glycerides, vegatable oils, animal oils, animal waxes, vegetable waxes, mineral waxes, resins and mixtures therof.

4. The coating according to claim 1, wherein the plasticizing agent is selected from the group consisting of resins, waxes, gums, grease, oils of animal origin, vegetable oils, waterproofing agents, polymeric plasticizers, phosphates, acetylated monoglycerides, glycerol, acids fatty, sorbitol, polyalcohols and mixtures thereof.

5. The coating according to claim 1, wherein the biodegradable film is selected from the group consisting of polysaccharides, microperforated film, parafilm, PLA (polylactic acid), poly (lactic acid), poly (hydroxybutyrate), poly (hydroxybutyrate) co-valerate), cellulose, waxes, starch films, alginate, vinyl cover, plastic paintings and mixtures thereof.

6. The coating according to claim 1, wherein the biodegradable film comprises perforations.

7. The coating according to claim 1, wherein the biodegradable film comprises perforations with a diameter between 0.5 mm and 2.0 mm.

8. The coating according to claim 1, wherein the coating further comprises growth promoting agents.

9. The coating according to claim 1, wherein the coating further comprises fungicides, bactericidal agents, insecticidal agents, nematicidal agents, molluscicidal agents, acaricides, pesticides, and biocides and mixtures thereof.

10. A process for coating plant material comprising the following steps:
a) kneading integrating a substrate, a binding agent and a plasticizing agent, and then incorporating the plant material, wherein the plant material is susceptible to dehydration and oxidation; and
b) coating the previous kneading (truffle) with a biodegradable film.

11. The proess according to claim 10, wherein the agglutinant agent is selected from the group consisting of an acrylic water-proofing agent, cattle fat, high oleic sunflower oil, 4% (w/v) modified starch-based gel, 6% (w/v) modified starch-based gel, 8% (w/v) modified starch-based gel, 4% (w/v) modified starch-based gel and toasted corn shhell, 4% (w/v) modified starch-based gel and corn husk, starch, dextrins, maltodextrins, carboximetylcellulose, cellulose, kitosane mixed with polyalcohols, pectin, agar, alginate, sorbitol, polyalcohols, glycerides, vegetable oils, animal oils, animal waxes, mineral waxes, resins and mixtures thereof.

12. The process according to claim 10, wherein the plasticizing agent is selected from the group consisting of resins, waxes, gums, grease, oils of animal origin, vegetable oils, waterproofing, polymeric plasticizers, phosphates, acetylated monoglycerides, glycerol, fatty acids, sorbitol, polyalcohols and mixtures thereof.

13. The process according to claim 10, wherein the biodegrable film is slected from the group consisting of polysaccharides, microperforated film, parafilm, PLA (polylactic acid), poly (lactic acid), poly (hydroxybutyrate), poly (hydroxybutyrate) co-valerate), cellulose, waxes, starch films, alginate, vinyl covers, plastic paintings and mixtures thereof.

14. The process according to claim 10, further comprising the step of carrying out perforations in the biodegradable film, after the step b).

15. The process according to claim 14, wherein the perforations comprise a diameter between 0.5 mm and 2.0 mm.

16. The process according to claim 10, wherein during step a) growth promoters are added.

17. The process according to claim 10, wherein during step a) agents selected from the group consisting of fungicides, bactericidal agents, insecticidal agents, nematicidal agents, molluscicidal agents, biological products, acaricides or acaricides, pesticides and biocides are added.

18. The process according to claim 10, wherein the plant material is selected from the group consisting of sugarcane buds and stakes.

19. (canceled)
